(19) United States
(12) Patent Application Publication
(10) Pub. No.: US 2013/0207376 A1
(43) Pub. Date: Aug. 15, 2013

(54) SECURITY ELEMENT, SECURITY DOCUMENT AND METHODS OF MANUFACTURE THEREOF

(71) Applicants: Matthew Charles Sugdon, Bridlington (GB); Neil Alex Hickman, Reading (GB); Robert William Harrison, Woking (GB)

(72) Inventors: Matthew Charles Sugdon, Bridlington (GB); Neil Alex Hickman, Reading (GB); Robert William Harrison, Woking (GB)

(73) Assignee: DE LA RUE INTERNATIONAL LIMITED, Viables, Basingstoke (GB)

(21) Appl. No.: 13/701,671

(22) PCT Filed: May 27, 2011
(86) PCT No.: PCT/GB2011/051020

§ 371 Date: Apr. 10, 2013

(30) Foreign Application Priority Data
Jun. 3, 2010 (GB) 1009274.0

(51) Int. Cl. B42D 15/00

(52) U.S. Cl. CPC B42D 15/00
USPC 283/85

(57) ABSTRACT

A security element for a security booklet includes a plurality of pages including a first outermost page and a second outermost page. The security element includes at least one line of stitching joining the plurality of pages to one another. The stitching is formed of at least a first thread and a second thread, the first thread disposed on an outer surface of the first page, and the second thread disposed on an outer surface of the second page. The first and second threads interlock at each of a series of spaced apertures through the plurality of pages along the line of stitching. At one or more selected aperture(s), a loop of the second thread extends to the outer surface of the first page. The first thread has an optical characteristic different from the second thread, so the second thread at the selected aperture(s) is distinguishable from the first thread.

This invention relates to security elements for security documents, particularly multi-page security documents, and corresponding methods of manufacture.

Numerous forms of multi-page security documents are well known. For example, passports are typically provided in the form of passport booklets having multiple pages joined to one another along a spine which doubles as a fold axis about which the booklet can be opened and closed. Similar booklets are also found in other fields, such as bank booklets. Other multi-page security documents include cheque books in which multiple elongate pages are joined to one another at one end.

In such security documents, the multiple pages are typically joined to one another by stitching. GB-A-2082504, for example, discloses a booklet for use as a bank book or similar in which a plurality of pages are joined along a spine by a line of lock stitching.

In the field of security documents it is desirable to reduce the scope for fraudulent alteration of the document by ensuring that the document cannot readily be dismantled. For this reason, the booklet disclosed in GB-A-2082504 includes plastic particles dispersed among the fibres of its pages and the threads used in the stitching have an outer surface coating of a fusable thermoplastic material. Once stitched, the assembly is clamped and heated with welding electrodes which fuse the threads and pages together at their crossing locations. The result is a fixture which will not easily be unpicked.

To further protect against fraudulent alteration of such documents, or the making of counterfeits, security documents typically also include a number of security elements such as fine line printing, intaglio printing, watermarks, optically variable elements such as holograms or Kinegrams™, perforations, laser marking and other such features which are difficult to modify and/or reproduce.

However, there is a constant need to provide new and superior security features as the technology available to potential counterfeiters advances.

In accordance with the present invention, a security element is provided for a security booklet comprising a plurality of pages including a first outermost page having an inner surface facing the remainder of the plurality of pages and an opposing outer surface, and a second outermost page having an inner surface facing the remainder of the plurality of pages and an opposing outer surface, the security element comprising at least one line of stitching joining the plurality of pages to one another, the stitching being formed of at least a first thread and a second thread, the first thread being disposed on the outer surface of the first outermost page, and the second thread being disposed on the outer surface of the second outermost page, the first and second threads being interlocked with one another at each of a series of spaced apertures through the plurality of pages provided along the line of stitching, wherein at one or more selected aperture(s), the interlock is configured such that a loop of the second thread extends to the outer surface of the first outermost page, the first thread having an optical characteristic different from that of the second thread, such that the or each loop of the second thread at the selected aperture(s) is optically distinguishable from the first thread.

In the present context, the term ‘interlock’ is used to refer to a region of the line of stitching where one of the threads passes around the other such that the two threads are intertwined with each other at that point. It is not intended to refer to any particular stitch type. As will be discussed below, many different types of stitches include interlocks suitable for configuring in the described manner. A “loop” is a length of thread configured such that both ends of the loop pass through the same aperture. Since the interlocks are arranged to be at the apertures, the loops of the second thread are substantially confined to the locations of the apertures and do not extend between apertures on the outer surface of the first outermost page by any significant amount.

By arranging selected interlocks to display loops of the second thread which are visually distinguishable in this way, the stitching which is used to construct the booklet also acts as a security element itself. Due to the typically small dimensions of the threads, and the loop configuration, the loops of thread at the selected apertures are not overtly conspicuous to an observer. However, when the document is tested for authenticity, inspection of the stitching will reveal whether the document is genuine. By arranging the first and second threads to have different optical characteristics, the loops of thread at the selected apertures are identifiable to the inspector. Further the use of different optical characteristics itself increases the security of the element since the counterfeiter attempting to produce a fraudulent copy would have to match the different optical characteristics of both threads.

It should be noted that, whilst the plurality of pages is described as having first and second “outermost” pages, these need not correspond to the outer pages of the finished security booklet. For instance, if the stitched plurality of pages is subsequently folded, as may often be the case, one of the “outermost” pages will become the central, internal sheet of the booklet. Similarly, additional layers such as protective cover layers could be applied to either or both of the “outermost” layers.

Also provided is a method of manufacturing a security element for a security booklet having a plurality of pages including a first outermost page having an inner surface facing the remainder of the plurality of pages and an opposing outer surface, and a second outermost page having an inner surface facing the remainder of the plurality of pages and an opposing outer surface, the method comprising stitching the plurality of pages to one another along a line by interlocking a first thread, provided on the outer surface of the first outermost page, with a second thread, provided on the outer surface of the second outermost page at each of a series of spaced apertures made through the plurality of pages along the line of stitching; wherein the first thread is held under a greater tension than the second thread during at least a portion of the stitching, such that at one or more selected aperture(s), the interlock is configured such that a loop of the second thread extends to the outer surface of the first outermost page, and wherein the first thread has an optical characteristic different from that of the second thread, such that the or each loop of the second thread at the selected aperture(s) is optically distinguishable from the first thread.

In general, at each selected aperture, the second thread loop should extend to the outer surface of the first outermost page in order to be visible. However, in preferred cases, at the or each selected aperture, the loop of the second thread extends past the outer surface of the first outermost page. This enhances the visibility of the loop under inspection. The extent of the loop can itself also be used to judge whether the document is genuine since it will be difficult for a counterfeiter to achieve precisely the correct tension during stitching to match the intended loops.

The optical characteristics of the first and second threads can differ from one another in any desirable way. In one preferred example, under visible light, the visible colour of the first thread is different from that of the second thread. That is, for example, the first thread can be white whereas the second thread may be red, or any other permutation of colours. This enables the authenticity of the booklet to be judged without the need for any special equipment such as UV illumination.

However, in a particularly preferred embodiment, the first and second threads appear visually similar to one another under a first lighting condition and visually distinct from one another under a second lighting condition. For example, under visible light, both threads may appear white (or any other colour) whereas when viewed in UV light one or other of the threads may exhibit a bright response, with the other dark, non-fluorescent. It is particularly advantageous if under visible light, the visible colours of the first and second threads are substantially the same since this will help conceal the presence of a security feature from the casual observer.

Preferably the first thread has a response to non-visible light which is different to that of the second thread. For example, either the first or second thread may comprise an ultraviolet or infrared responsive material. So as not to reveal the presence of such material under usual lighting conditions, it is advantageous if the ultraviolet responsive or infrared responsive material is not visible under visible light.

Alternatively, the first thread or the second thread could comprise a phosphorescent, luminescent or fluorescent material. Again, both threads may have the same appearance under visible lighting conditions with one, for example, a phosphorescent or luminescent thread, producing a glow or other effect on excitation under darkened lighting conditions.

In further preferred examples, the first thread or the second thread could comprise a photochromic or thermochromic material. Photochromic materials change colour on application of light whereas thermochromic materials change colour on application of heat. Thus, authenticity of the element may be checked by subjecting the stitching to appropriate light or heating conditions.

Each thread could comprise a single ply or could include multiple plies of the same type. However, in certain preferred embodiments the first thread or the second thread comprises at least two plies, at least one of the plies in the thread having an optical characteristic different from the remaining ply or plies in the thread. The use of multiple distinct plies enhances the complexity of the security element and therefore the difficulty of reproduction by counterfeiters. Preferably at least some of the plies have different visible colours. Thus, a single thread will appear as having two or more colours twisted around one another. In a particularly preferred embodiment, the first and second threads each comprise at least two plies of different colours, the combination of colours in the first thread being different from that in the second thread.

The first and second threads can be made of any suitable material. In preferred examples, the first or second thread comprises any of: natural fibres, preferably cotton, or viscose; synthetic fibres, preferably polymeric filaments, polyester-cotton blends, nylon or nylon-cotton blends; and metallic fibres, preferably metal wire.

Any of the series of apertures could be selected for provision of a visible loop. A single aperture in the series, for example the central aperture, could be selected if desired. However, preferably, the selected apertures comprise every n^{th} aperture of the series of apertures, preferably every second aperture. This results in a pattern that is easily recognisable to an inspector. Alternatively, in other preferred examples, the selected apertures could comprise all of the series of apertures. That is, every aperture may be provided with a visible loop of the second thread.

The stitching may be provided in the form of any known stitch type in which (at least) two threads interlock at apertures as described above. In particularly preferred examples, the line of stitching is formed using a two thread interlock stitch (also known as “lock stitch” or “straight stitch”: here the term ‘interlock stitch’ is being used to refer to the specific stitch type) or a two thread chain stitch such as that set out in ISO 401. This latter form of stitching is more secure since it is more difficult to unravel. It should be noted that the paths of the two threads need not be similar or symmetrical: for example, in chain stitch, one thread will typically follow a far more convoluted path than the other (as will be depicted below).

The line of stitching could extend to the edges of the plurality of pages where the ends of the threads are left exposed. This is fast and compatible with sewing a multitude of multi-page documents with a single line and then dividing the assembly into individual documents by cutting after stitching is complete. However, preferably, the line of stitching does not extend to an edge of the plurality of pages and a portion of the stitching adjacent at least one end of the line includes back tack stitches. “Back tack” stitches are formed by reversing the direction of sewing at an end of the line and reinforcing one or more stitches adjacent to the end by forming further interlocks through the existing apertures. This makes the structure much more difficult to unpick.

Typically, the series of apertures will be produced during the stitching operation by a needle carrying one or other of the threads punching the pages. Thus, preferably, the series of apertures are spaced at substantially equal intervals along the line of stitching. However, this need not be the case.

Further provided is a security document comprising a security element as described above, the security document comprising a plurality of pages joined to one another by the line of stitching. Any sort of multi-page security document is envisaged.

In a particularly preferred embodiment, the line of stitching is aligned with a spine of the security document, about which the plurality of pages are foldable, the first outermost page of the plurality of pages forming a centre page of the security document and the second outermost page of the plurality of pages forming an outer page of the security document.

Advantageously, the security document further comprises further comprising a protective cover layer adhered to at least a portion of the outer surface of the second outermost page of the plurality of pages, the second thread being disposed between the second outermost page and the protective cover layer. This arrangement makes access to the second thread difficult and assists in preventing the stitching being unpicked.

In a particularly preferred implementations, the security document is a security booklet, preferably a passport.

To further enhance security of the security document, preferably at least one of the plurality of pages and/or the protective cover comprises one or more security features, preferably fine-line printing; intaglio printing; embossing; metallic foils; optically variable elements, holograms, Kinegrams™, or angular dependent colour shifting effects based on liquid crystal films or pigments or thin film interference coatings or pigments.

Finally, it should be noted that whilst the formation of the security element will inherently affix the plurality of pages to one another, this need not be provided as the primary means of joining. For example, the plurality of pages could already joined to one another by any desirable fastening means, with the disclosed security element being provided, in addition, for decorative and security purposes.

Examples of security elements, security documents and methods of manufacture will now be described and contrasted with conventional security documents, with reference to the accompanying drawings, in which:

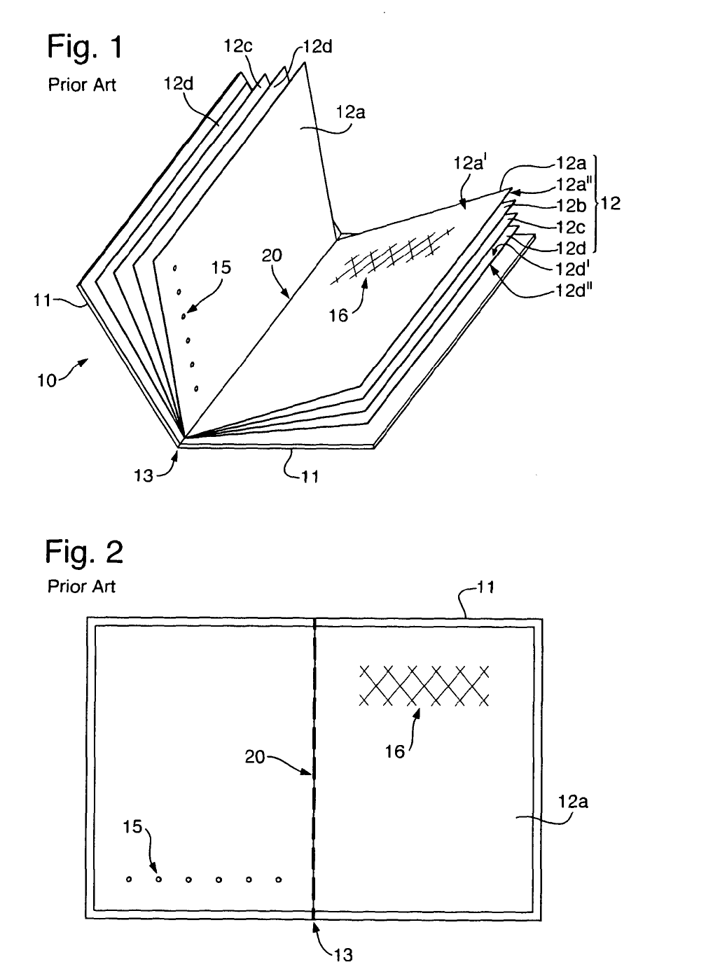

FIG. 1 depicts an exemplary conventional multi-page security document in the form of a booklet in perspective view;

FIG. 2 shows the conventional booklet of FIG. 1 open in plan view;

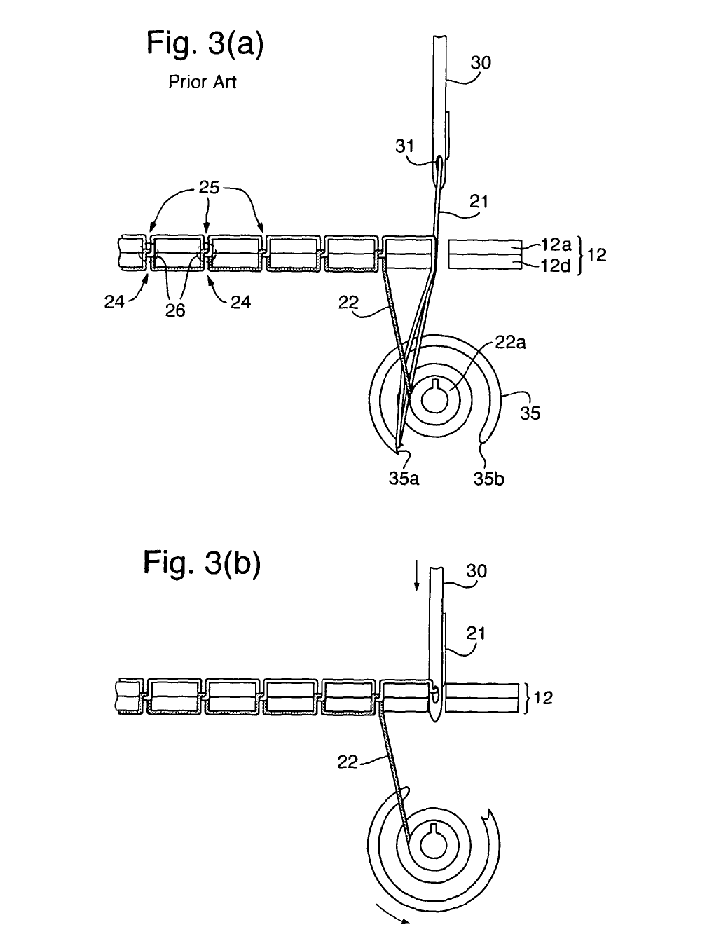

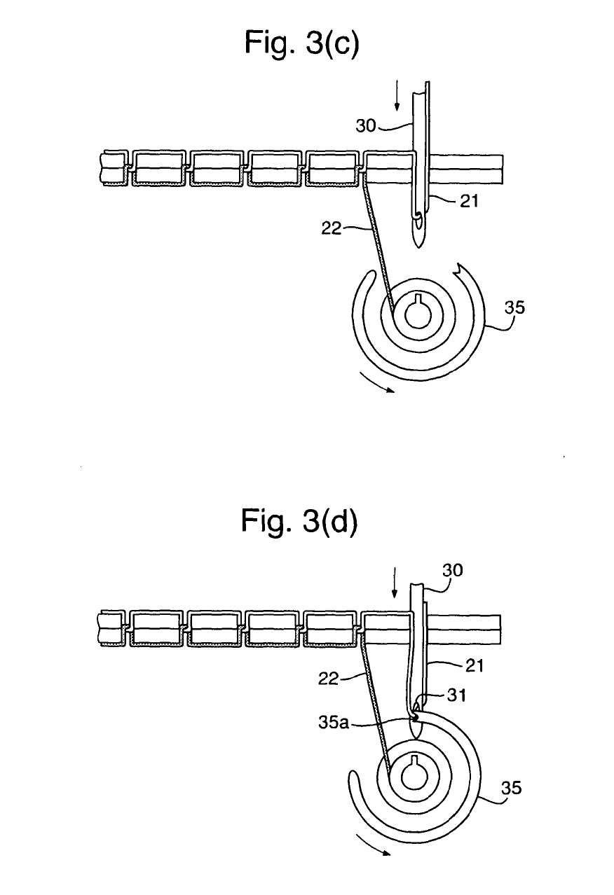

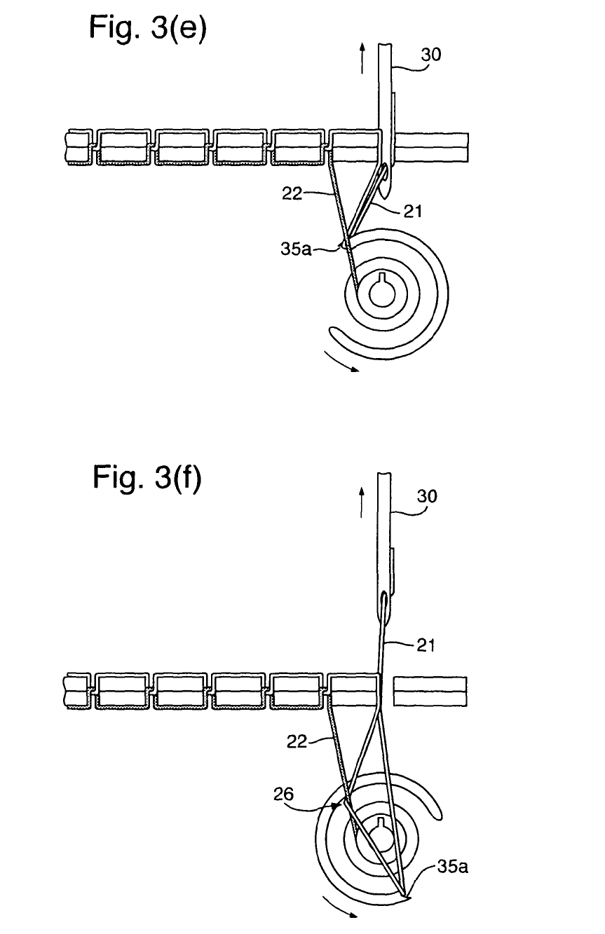

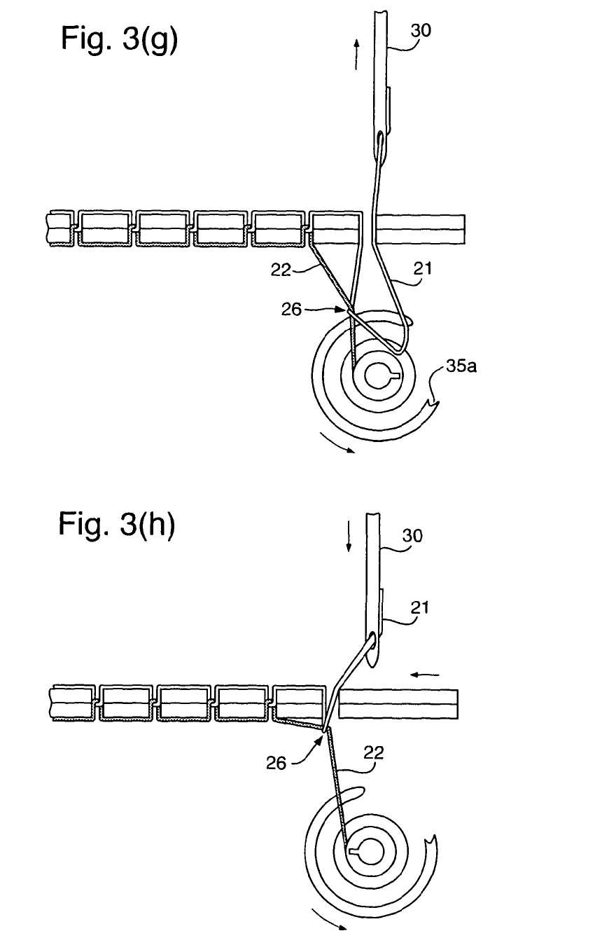

FIGS. 3a to 3h show steps in a conventional stitching process, and apparatus therefor;

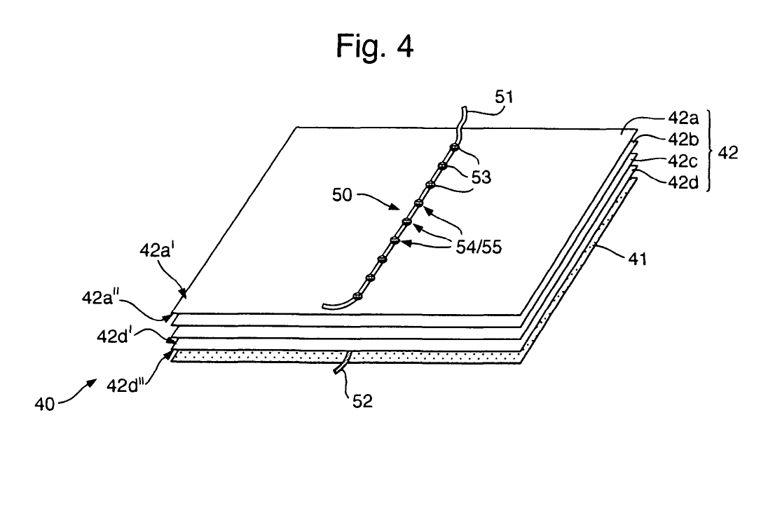

FIG. 4 schematically shows the construction of a security element according to a first embodiment;

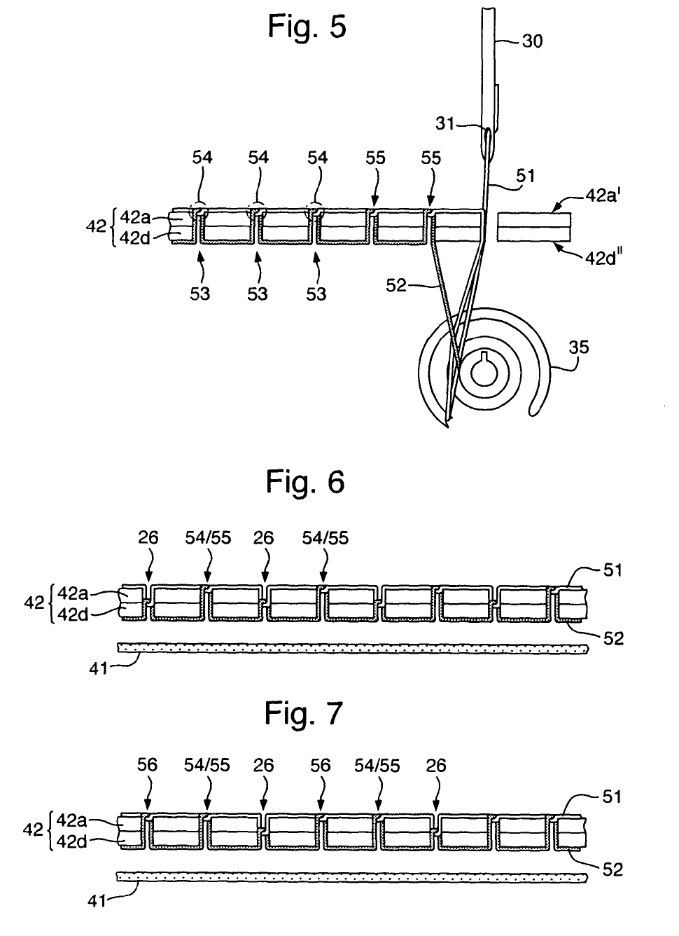

FIG. 5 depicts a step in the stitching process used to manufacture the security element depicted in FIG. 4, and apparatus therefor;

FIG. 6 shows a portion of a security element according to a second embodiment;

FIG. 7 shows a portion of a security element according to a third embodiment;

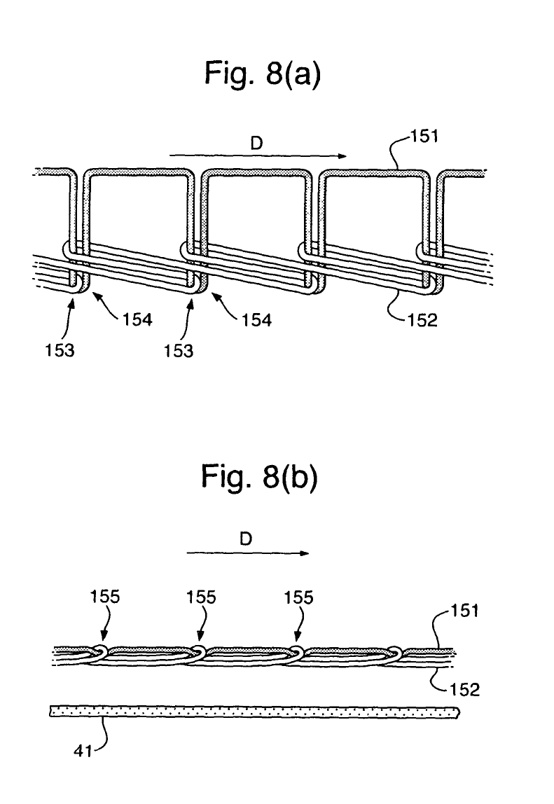

FIGS. 8a and 8b show details of a stitch type used in a fourth embodiment;

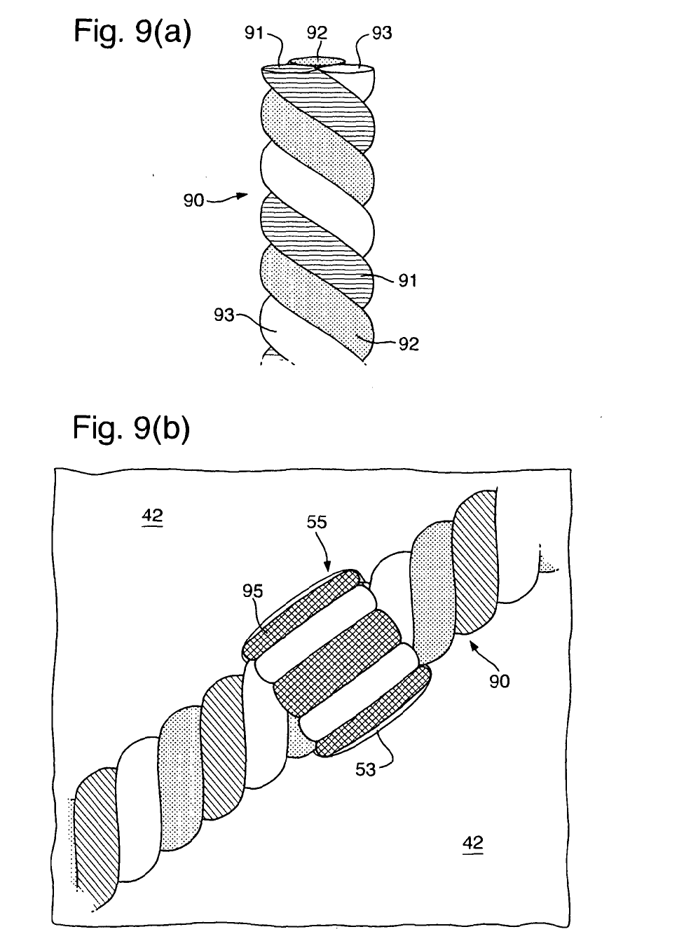

FIGS. 9a and 9b show portions of threads having multiple plies;

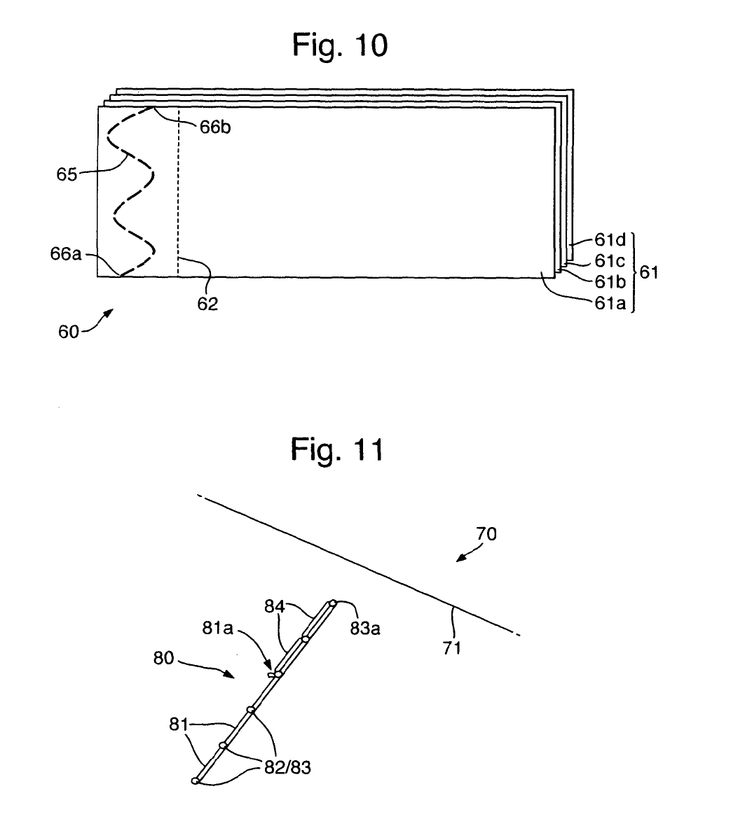

FIG. 10 depicts a security element applied to a security booklet according to a fifth embodiment; and

FIG. 11 shows a detail of a security element according to a sixth embodiment.

The security element described herein can be applied to any form of multi-page security document. In the description below such documents will generally be referred to as “booklets” although it will be understood that this refers to generally to any structure in which multiple pages are joined to one another. The term “page” generally indicates a portion of a sheet material such as paper, polymer or a laminate. Pages are generally moveable relative to one another although this is not essential. It is envisaged that the security element may be used in any form of multi-page security document, including passports, bank books, cheque books, ticket books, etc.

FIG. 1 shows an example of a known security booklet such as a passport. The booklet 10 includes a number of internal pages 12 of which four are shown in the FIGS. 12a, 12b, 12c and 12d). Each page is joined along its centre fold line 13, and an outer protective cover layer 11 is provided. The joining of the internal pages 12 is typically achieved by a line of stitching 20 as will be described further below. The outer cover 11 is typically affixed to the stitched pages by adhering it to the adjacent page 12d. The fold line 13 acts as a spine for the booklet.

Of the four internal pages shown, the uppermost page 12a and the lowermost page 12d each constitute outermost pages of the plurality of internal pages 12. Uppermost page 12a forms the central page of the booklet 10 such that, when the booklet is opened to reveal the line of stitching 20, the page 12a is continuous across the fold line. The outermost page 12a has an outer surface 12a′ which faces away from the remainder of the plurality of pages 12b, 12c and 12d, and a inner surface 12a″ which faces towards the remainder of the plurality of pages. The other outermost page 12d sits adjacent to, and in practice may be adhered to, the protective cover layer 11. Outermost page 12d has an inner surface 12d′ facing the remainder of the plurality of pages 12a, 12b and 12c, and an opposing outer surface 12d″ which faces (and may be adhered to) the interior of protective cover 11. Typically, the security booklet will include one or more security features such as perforations 15 and a security print 16, and may include a data page covered by a laminate patch (not shown). Any other suitable security features such as watermarks, optically variable elements or otherwise may be provided as desired.

FIG. 2 shows the same security booklet in plan view with the centre page 12a open. The line of stitching 20 is represented by a bold dashed line along the spine 13. This is formed using an interlocking stitch as will be demonstrated with reference to FIG. 3.

FIG. 3 shows a cross-section along the spine 13, depicting formation of the stitching 20. The stitching 20 is formed of first and second threads 21 and 22 respectively. In FIG. 3, it will be noted that the first and second threads are depicted using different colours. However, this is purely for clarity and in fact the conventional document will use two threads of the same type. FIG. 3a shows only the two outermost pages 12a and 12d in cross-section. In practice, any other pages such as 12b and 12c will be located between the end pages 12a and 12d. However, such additional pages are excluded here for clarity. A first needle 30 is threaded with a first thread 21 through its eye 31. The first needle 30 is arranged so as to point towards the uppermost page 12a and is carried by a drive means (not shown) which is configured to move the first needle 30 towards and away from the document as will be described further below.

The second needle 35 is an arcuate needle having a hooked leading edge 35a and plain trailing edge 35b. The second needle 35 is arranged to rotate in an anti-clockwise direction during stitching at a location which is fixed relative to the lateral position of the first needle 30. The first and second needles 30 and 35 are driven synchronously with one another by a control means. All of this apparatus can be provided by a conventional sewing machine, and is well known.

As the first needle 31 moves towards and away from the document, it punctures the document to produce apertures 25 as shown. The first and second threads 21 and 22 are interlocked with one another at each aperture to produce interlocks 26 as will now be described in more detail.

FIG. 3b shows the first step in forming a stitch. The first needle 30, carrying first thread 21, is driven through the pages 12 to be joined, creating an aperture. As shown in FIG. 3c, the first needle 30 continues to move through the pages 12, pulling the first thread with it. At the same time, the arcuate second needle 35 is rotating anti-clockwise. At its lowermost point, as shown in FIG. 3d, the vertical position of eye 31 of the first needle 30 approximately aligns with that of the leading edge 35a of the arcuate needle 35. The hooked leading edge 35a thus encounters the first thread 21 carried by the eye 31 of the first needle 30 and carries a loop of the first thread forward, as shown best in FIG. 3e.

The second thread 22 meanwhile is loaded on a bobbin 22a which conveniently sits concentrically with arcuate needle 35. The path of the second thread 22 is intersected by the loop of the first thread 21 carried by arcuate needle 35 and, as the arcuate needle 35 continues to rotate, the loop of the first thread 21 is passed around the second thread 22 and creating an interlock 26 as shown in FIG. 3f (and also 3a). When the arcuate needle 35 reaches a certain point in its rotation, the loop of first thread 21 is no longer retained by the hooked leading edge 35a, and the upward action of first needle 30 causes the loop to be pulled back towards the aperture 25 created in the pages to be joined. This is shown in FIG. 3g. Due to the interlock 26, the second thread 22 is also pulled towards the aperture, as shown in FIG. 3h. Finally, the interlock is pulled inside the aperture and the stitch is finished. Meanwhile, the pages being stitched are advanced either manually or by suitable driving means in a lateral direction relative to the first and second needles such that when the first needle 30 moves down in the next cycle, it will pierce a new aperture. The cycle is repeated to create a line of stitching.

In conventional documents, the interlock 26 is desirably hidden within the pages to be joined, as shown in the cross-sections of FIG. 3. This is primarily to improve the appearance of the line of stitching but also its resilience since the interlock is not exposed. This is achieved by balancing the tension on the first and second threads, which is controlled by the stitching apparatus.

FIG. 4 schematically depicts a security document 40 provided with a security element 50 in accordance with a first embodiment of the invention.

In this example, the security document 40, under construction in FIG. 4, is to be a booklet akin to that shown in FIGS. 1 and 2. Four internal pages 42a, 42b, 42c and 42d are provided (collectively labelled 42), alongside a protective outer cover 41. The various layers are shown spaced apart from one another in FIG. 4 for clarity, although in practice they will be placed directly on top of one another. As in the case of the FIG. 1 booklet, security features such as holograms and security prints may be provided on the internal pages 42 and/or the outer cover 41. Typically, one or more of the pages will be provided with printed data which may be covered by a laminate patch. This could be located on any of the internal pages 42 or on the inside of the protective cover 41.

The pages 42 are joined to one another by security element 50 in the form of a line of stitching. It should be noted that, in this example, the protective outer cover 41 is not included in the pages to be stitched by security element 50. Instead, the protective cover 41 is bonded to lowermost page 42d after stitching is complete, as will be described further below.

The uppermost page 42a is an outermost page which will form the central page of the booklet if it is ultimately folded along stitching line 50 to create a spine. The end page 42a has an outer surface 42a′ and an opposing inner surface 42a″ which faces the remaining internal pages 42b, 42c and 42d. Of course, any number of such pages can be provided.

The other outermost page 42d likewise has an inner surface 42d′ facing the other pages 42a, 42b and 42c and an opposing outer surface 42d″.

The line of stitching 50 is produced using a modified version of the process described above. The first thread 51 is provided on the outer surface of uppermost page 42a, and second thread 52 on the outer surface of lowermost page 42d. That is, the “stitches” between each interlock on the surface of page 42a are formed of the first thread 51 whereas those on the outer surface of the lowermost page 42d (not visible) are formed of second thread 52. The apertures 53 are formed in the same manner as described above. However, in the embodiment, loops 55 of the second thread 52 are now visible on the side of the uppermost sheet 42a at each interlock 54. The interlocks are located at the apertures such that both ends of each loop pass through the same aperture and only that portion of the second thread which crosses over the first is visible. The second thread does not extend laterally between apertures on the outer surface of page 42a to any significant degree.

FIG. 5 shows this in more detail, alongside apparatus suitable for performing the stitching. The stitches are formed using a series of steps similar to those already described in respect of FIG. 3, using a first needle 30 and a second, arcuate needle 35. However, the relative tension between the first thread 51 and second thread 52 is adjusted such that, when the interlock is pulled into the aperture 53, a loop of the second thread 52 is pulled to the upper surface 42a′ of the upper end page 42a. Thus at each interlock 54, as shown in FIG. 5, a loop 55 of the second thread 52 crosses over the first thread 51 at the extremity of each aperture 53, and is revealed at each interlock 54 when the end page 42a is viewed.

The desired difference in tension between the threads can be achieved by modifying the sewing apparatus accordingly. Many conventional sewing apparatus have means for adjusting the tension to account for different material and thread types, and such adjustment means can be made use of to achieve the desired tension here. It should also be noted that the desired effect could alternatively be achieved by arranging the relative tension on the two threads such that loops of the first thread 51 are pulled through to the lower surface 42d″ if preferred.

In order to make the loops 55 detectible, the first and second threads 51 and 52 have differing optical characteristics. The difference in optical characteristics may be visible or non-visible to a human observer, as will be described in more detail below. In a first example, as depicted in the Figures, the first and second threads may be of different visible colours. For example, the first thread may be light whereas the second thread may be dark. The use of differing visible appearances ensures that the loops 55 can be detected without the need for any special equipment.

The authenticity of the security element can be checked by examining the line of stitching 50 and confirming that the loops 55 are visible to the extent expected. Given that the dimensions of such stitching, and in particular the apertures and interlocks are typically very small (for example a typical thread has a diameter of less than 1 mm, and preferred threads have diameters between 50 and 500 microns, still preferably 50 to 250 microns), the presence of loops 55 is not immediately obvious to an observer and so is unlikely to be copied by a counterfeiter. Further, it is difficult for counterfeiters to achieve the correct level of tension during stitching which will produce loops 55 exactly as expected, since conventional sewing apparatus available to counterfeiters will typically be arranged to conceal interlocks either within the thickness of the material being fastened, or behind the stitched material (i.e. on the side of the lower end page 42d).

In the example shown in FIG. 4, all of the interlocks 54 along the series of apertures 53 are arranged with the loop 55 of the second thread 52 at the surface of page 42a such that all the loops are visible. However, this need not be the case and in general such visible interlocks need only be produced at a selection of apertures 53. Any of the apertures could be selected. For example, a single aperture such as the central aperture may be selected and provided with a visible loop 55. Thus, authenticity of the resulting document would be judged by looking for the one selected visible loop with the remaining apertures containing non-visible interlocks.

Alternatively, the selected apertures could comprise every n^{th} aperture along the series. For example, FIG. 6 shows a cross section along the line of stitching in a second embodiment. Here, every second aperture is selected. That is, at every second aperture, a loop 55 of the second thread extends to the surface of upper end page 42a, making every second interlock 54 visible. The remaining interlocks 26 are conventional in that the second thread is not visible from the upper surface. Any value of n could be used to form a similar pattern. Alternatively, every n^{th} aperture could have a conventional interlock 26 with the remainder being visible interlocks 54. Repeating patterns such as these are particularly straightforward for an inspector to identify in order to authenticate the document.

Selection of apertures can be achieved by adjusting the tensioning on the sewing apparatus dynamically (i.e. between formation of one interlock and the next), and the sewing apparatus may include a controller adapted to perform such control of the tension. Memory means for storing the desired pattern of interlocks may also be provided for supplying instruction to the controller.

FIG. 6 also shows the location of protective cover 41 relative to the sheet 42 which are joined to one another by the line of stitching. Specifically, it will be seen that protective cover 41 is not included in the layers to be joined by stitching and that second thread 52 is disposed between the lowermost page 42d and the interior surface of cover 41. In practice, the cover 41 may be bonded to the end page 42d after stitching is complete, for example, by using adhesive. Thus, the second thread 52 is not easily accessible.

FIG. 7 shows a cross-section through a portion of a security element according to a third embodiment including visible interlocks 54 as already described as well as another version of visible interlock 56. It will be noted that, in the case of interlock 56, the loop of the second thread extends only to the surface of page 42a and not beyond, whilst at interlock 54 the loop 55 extends a short way beyond the page surface. Both options result in detectable interlocks. In practice, the precise extent of the loop 55 beyond the surface of page 42a may be set as desired by appropriate selection of thread tension during machining and may be used as a further parameter by which authenticity of the element is checked.

In the FIG. 7 embodiment, both forms of visible interlock 54 and 56 are provided alongside conventional interlocks 26. In this example, a repeating sequence of conventional interlocks 26/visible interlock 56/visible interlock 54 is deployed. Again, such repeating patterns are readily detectable by an inspector.

As in the case of the FIG. 6 embodiment, the protective cover 41 is not included in the layers to be stitched and may be applied after stitching using adhesive, for example.

FIGS. 8a and b depict an alternative stitch type to that used in the previously described embodiments. In this fourth embodiment, a two thread chain stitch is employed, such as that defined in ISO stitch type 401. FIG. 8a shows the stitch in an expanded form for clarity, whereas in FIG. 8b, the threads have been tensioned so as to reveal loops of the second thread at the upper surface of the pages, in accordance with the previously described techniques. FIGS. 8a and b do not show the pages 42, for clarity, but it will be understood that these are present in the same as previously described, and that the threads pass through apertures in the pages in the same way as before. As shown in FIG. 8a, the first thread 151 follows a similar path to that in the previously described stitch type. The second thread 152, on the other hand, follows a more convoluted path. At each aperture 153, the second thread 152 interlocks with the first thread, as indicated at 154, and then crosses back on itself to hook around the first thread 151 at the previous aperture. The arrow D indicates the direction of stitch formation.

When the threads are tensioned appropriately, as shown in FIG. 8b, the loops 155 of the second thread 152 formed at each interlock, are pulled to the upper surface of the pages and become visible in the same manner as described with respect to the previous embodiments, due to the two threads' different optical characteristics. Again, the tension may be varied along the line of stitching no that only selected loops may become visible in this way.

As before, the protective cover 41 is preferably not included in the line of stitching and is adhered to the stitched pages subsequently, thereby concealing the remainder of the second thread 152.

Apart from the stitch type, all other features of the fourth embodiment are formed in the same manner as described in the previous embodiment

As already noted, the presence of loops 55/155 at the surface of the uppermost page 42a is made identifiable by the use of threads with different optical characteristics. In the previous examples, this has been achieved by using threads of two different visible colours. However, many other options may also be appropriate. In particular, it can be beneficial if one or other of the threads has a non-visible response. That is, it emits or reflects radiation outside the visible spectrum and/or responds only to radiation outside the visible spectrum. For example, one of the threads may be UV- or IR-responsive whilst the other is not. An example of a UV responsive stitching thread is supplied by Security Printing Consulting AG.

Other examples of substances which will enhance security of the element include phosphorescent, fluorescent and luminescent substances.

Alternatively, one or other of the threads can include a substance which undergoes a visual change under certain conditions. For example, the substance may be photochromic or thermochromic.

The use of such non-visible or responsive materials leads to the possibility of selecting a combination wherein the first and second threads have the same appearance as one another when viewed under normal lighting conditions, but appear different from one another under alternative lighting conditions. For example, the first and second threads may both have the same visible colour, but one contains a UV-responsive substance and the other not. Under normal ambient conditions, both threads will have near identical appearance and it will be difficult or impossible to identify loops 55/155. However, under selected lighting conditions, in this case UV light, the thread including the UV-responsive substance would appear bright whereas the other will be dark. This will render the loops 55/155 visible.

Alternatively, where both threads have the same visible colour and one includes a phosphorescent substance, the loops may appear indistinguishable under ambient light conditions, but in the dark, the thread containing the phosphorescent substance will emit light whereas the other will remain dark. Again, the loops 55/155 thus become visible. Any combination of such optical characteristics can be employed.

If photochromic or thermochromic materials are used, a predetermined application of light or heat (or cooling) may be used to induce the expected changes in appearance and so reveal the loops 55/155.

Suitable thread materials include fibres such as cotton, polymer fibres and blends such as polycotton, or even metallic fibres (i.e. wires) could be utilised if desired. The above-mentioned substances for achieving the desired optical effects can be included in the threads using well known techniques such as dyeing or inclusion in the bulk thread material prior to extrusion, coating of the thread.

Many thread types are made up of multiple “plies” twisted together to form a thread. This in itself can be made use of in order to impart complex optical characteristics to each thread.

For example, FIG. 9a shows a section of a 3-ply thread 90. The three plies 91, 92 and 93 are twisted together as shown to form one cohesive thread. Either or both of the first and second threads 51 and 52 could include any number of plies assembled in this manner. Within each thread, the optical characteristics of the plies themselves can be varied. For example, in FIG. 9a, each of the plies 91, 92 and 93 has a different visible colour as represented by different shading. The manner in which the plies are twisted together leads to repeating “stripes” of the different colours along the length of the thread. Of course, the differing optical characteristics need not be in the form of visible colours but could take any other form, as discussed above.

FIG. 9b shows a magnified schematic of one selected aperture 53 where a loop 55 of the second thread 95 is visible against the first thread 90. Here, the first thread 90 is a 3-ply thread having three different visible colours as shown in FIG. 9a, whereas the second thread 95 is a 2-ply thread having two plies of the same visible colour but one including a UV-responsive substance, represented by hatching in the Figure.

The use of an increased number of different optical characteristics in this way further enhances the complexity of the security and hence the difficulty of fraudulent reproduction.

The examples above have focussed on the use of the security element in foldable booklet documents where the stitching is aligned with a fold line of the booklet. However, this need not be the case. For example, FIG. 10 schematically depicts a security element 65 according to a fifth embodiment of the invention which is applied to another multi-layer security document such as a cheque book. Here, the document 60 is shown to comprise four pages 61a, 61b, 61c and 61d, collectively labelled 61. For clarity, the pages are shown spaced from one another, but in practice they will be bound together. This binding may be achieved by the security element 65 itself or could be provided by some other means, such as adhesive, with the security element 65 acting primarily as an authenticity check. Thus, the security element 65 may be applied after the various pages have already been joined.

In this example, the pages 61 are bound to one another adjacent their left-hand extremity as viewed in FIG. 10. A line of stitching 65 is provided in this region. The stitching is produced in the same manner as described above with respect to FIGS. 4 and 5 with selected apertures along the line having visible interlocks where the second thread (provided on the rear surface of back page 61d) extend in loops through to the front surface of page 61a and are visible. This is not shown in FIG. 10. As in the previous embodiments, any of the apertures along the line can be selected. Again, the first and second threads have differing optical characteristics as previously described in order to render the interlocks visible at the selected apertures.

It will be noted that the embodiment of FIG. 10 further differs from the previous examples in that the line of stitching 65 is not straight, but rather follows a undulating path. Of course, any desirable path shape could be chosen and more than one line of stitching may be provided if desired.

In this example, each of the pages 61 includes a line of perforations 62 for separating a portion of the page 61 from the bound region including stitching line 65. However, this is of course optional.

It will also be noted that the embodiment of FIG. 10 does not include any protective cover layer akin to cover 41 described above, although such a cover could be added if desired.

In the FIG. 10 embodiment, it will be noted that the stitching line 65 extends to meet the periphery of the pages 61 as indicated at points 66a and 66b. This can be desirable if, for example, it is intended to apply the security element 65 across several such documents 60 in one step, and out the material into individual documents after stitching.

However, in many examples, it is preferred that the line of stitching does not extend to the edge of the document, since this can lead to a weak point which enables unpicking of the stitching.

FIG. 11 shows a detail of a security element 80 applied to a document 70, having a series of apertures 83 which stop some distance from the edge 71 of the document 70. Here, the first thread 81 is shown to be light in colour with visible interlocks revealing loops of the (dark) second thread 82 at each of the apertures of 83. To further enhance the security of the line of stitching, this embodiment includes two “back tack” stitches which are labelled 84. These are produced by reversing the direction of stitching once the last stitch, ending with aperture 83a, has been produced. This can be performed by reversing the movement of the document 70, and forming two additional stitches exactly in line with the two end stitches of the series. The two threads can then be out leaving an end 81a of the first thread and corresponding end of the second thread on the other side which are tightly secured and thus resistant to unpicking. Any number of back tack stitches can be so provided.

The so-produced security element can be examined for authenticity by an inspector or by a machine, using magnification if necessary together with any appropriate lighting conditions in order to reveal the intended optical effect. The difficulty of forgery is thus enhanced.

1. A security element for a security booklet comprising a plurality of pages including a first outermost page having an inner surface facing the remainder of the plurality of pages and an opposing outer surface, and a second outermost page having an inner surface facing the remainder of the plurality of pages and an opposing outer surface, the security element comprising at least one line of stitching joining the plurality of pages to one another, the stitching being formed of at least a first thread and a second thread, the first thread being disposed on the outer surface of the first outermost page, and the second thread being disposed on the outer surface of the second outermost page, the first and second threads being interlocked with one another at each of a series of spaced apertures through the plurality of pages provided along the line of stitching, wherein at one or more selected aperture(s), the interlock is configured such that a loop of the second thread extends to the outer surface of the first outermost page, the first thread having an optical characteristic different from that of the second thread, such that the or each loop of the second thread at the selected aperture(s) is optically distinguishable from the first thread.

2. A security element according to claim 1, wherein at the or each selected aperture, the loop of the second thread extends past the outer surface of the first outermost page.

3. A security element according to claim 1, wherein, under visible light, the visible color of the first thread is different from that of the second thread.

4. A security element according to claim 1, wherein the first and second threads appear visually similar to one another under a first lighting condition and visually distinct from one another under a second lighting condition.

5. A security element according to claim 4, wherein, under visible light, the visible colors of the first and second threads are substantially the same.

6. A security element according to claim 1, wherein the first thread has a response to non-visible light which is different to that of the second thread.

7. A security element according to claim 6, wherein the first or second thread comprises an ultraviolet-responsive or infrared-responsive material.

8. A security element according to claim 7, where the ultraviolet-responsive or infrared-responsive material is not visible under visible light.

9. A security element according to claim 1, wherein the first thread or the second thread comprises a phosphorescent, luminescent or fluorescent material.

10. A security element according to claim 1, wherein the first thread or the second thread comprises a photochromic or thermochromic material.

11. A security element according to claim 1, wherein the first thread or the second thread comprises at least two plies, at least one of the plies in the thread having an optical characteristic different from the remaining ply or plies in the thread.

12. A security element according to claim 11, wherein the at least two plies each have a different visible color.

13. A security element according to claim 12, wherein the first and second threads each comprise at least two plies of different colors, the combination of colors in the first thread being different from that in the second thread.

14. A security element according to claim 1, wherein the first or second thread comprises any of: natural fibers, synthetic fibers, and metallic fibers.

15. A security element according to claim 1, wherein the selected apertures comprise every n^{th} aperture of the series of apertures.

16. A security element according to claim 1, wherein the selected apertures comprise all of the series of apertures.

17. A security element according to claim 1, wherein the line of stitching is formed using a two thread interlock stitch or a two thread chain stitch.

18. A security element according to claim 1, wherein the line of stitching does not extend to an edge of the plurality of pages and a portion of the stitching adjacent at least one end of the line includes back tack stitches.

19. A security element according to claim 1, wherein the series of apertures are spaced at substantially equal intervals along the line of stitching.

20. A security document comprising a security element according to claim 1, the security document comprising a plurality of pages joined to one another by the line of stitching.

21. A security document according to claim 20, wherein the line of stitching is aligned with a spine of the security document, about which the plurality of pages are foldable, the first outermost page of the plurality of pages forming a centre page of the security document and the second outermost page of the plurality of pages forming an outer page of the security document.

22. A security document according to claim 20, further comprising a protective cover layer adhered to at least a portion of the outer surface of the second outermost page of the plurality of pages, the second thread being disposed between the second outermost page and the protective cover layer.

23. A security document according to claim 20, wherein the security document is a security booklet.

24. A security document according to claim 20, wherein at least one of the plurality of pages and/or a protective cover comprises one or more security features.

25. A method of manufacturing a security element for a security booklet having a plurality of pages including a first outermost page having an inner surface facing the remainder of the plurality of pages and an opposing outer surface, and a second outermost page having an inner surface facing the remainder of the plurality of pages and an opposing outer surface, the method comprising:
stitching the plurality of pages to one another along a line by interlocking a first thread, provided on the outer surface of the first outermost page, with a second thread, provided on the outer surface of the second outermost page at each of a series of spaced apertures made through the plurality of pages along the line of stitching;
wherein the first thread is held under a greater tension than the second thread during at least a portion of the stitching, such that at one or more selected aperture(s), the interlock is configured such that a loop of the second thread extends to the outer surface of the first outermost page,
and wherein the first thread has an optical characteristic different from that of the second thread, such that the or each loop of the second thread at the selected aperture(s) is optically distinguishable from the first thread.

26. A method of manufacturing a security element for a security booklet according to claim 25, wherein the security element is a security element for a security booklet comprising a plurality of pages including a first outermost page having an inner surface facing the remainder of the plurality of pages and an opposing outer surface, and a second outermost page having an inner surface facing the remainder of the plurality of pages and an opposing outer surface, the security element comprising at least one line of stitching joining the plurality of pages to one another, the stitching being formed of at least a first thread and a second thread, the first thread being disposed on the outer surface of the first outermost page, and the second thread being disposed on the outer surface of the second outermost page, the first and second threads being interlocked with one another at each of a series of spaced apertures through the plurality of pages provided along the line of stitching, wherein at one or more selected aperture(s), the interlock is configured such that a loop of the second thread extends to the outer surface of the first outermost page, the first thread having an optical characteristic different from that of the second thread, such that the or each loop of the second thread at the selected aperture(s) is optically distinguishable from the first thread.

27. A method of manufacturing a security document according to claim 20, the method comprising:
stitching the plurality of pages to one another along a line by interlocking a first thread, provided on the outer surface of the first outermost age, with a second thread, provided on the outer surface of the second outermost page at each of a series of spaced apertures made through the plurality of pages along the line of stitching;
wherein the first thread is held under a greater tension than the second thread during at least a portion of the stitching, such that at one or more selected aperture(s), the interlock is configured such that a loop of the second thread extends to the outer surface of the first outermost page,
and wherein the first thread has an optical characteristic different from that of the second thread, such that the or each loop of the second thread at the selected aperture(s) is optically distinguishable from the first thread.
